(19) United States
(12) Patent Application Publication
(10) Pub. No.: US 2016/0246164 A1
(43) Pub. Date: Aug. 25, 2016

(54) MAGNIFICATION SCOPE/WIRELESS PHONE CAMERA ALIGNMENT SYSTEM

(71) Applicants: David Forbush, Centerville, UT (US); Colby Forbush, Clearfield, UT (US)

(72) Inventors: David Forbush, Centerville, UT (US); Colby Forbush, Clearfield, UT (US)

(21) Appl. No.: 15/046,216

(22) Filed: Feb. 17, 2016

Related U.S. Application Data
(60) Provisional application No. 62/117,650, filed on Feb. 18, 2015.

(51) Int. Cl. G03B 17/56; H04M 1/02; G02B 25/00

(52) U.S. Cl. CPC G03B 17/566; G03B 17/565; G02B 25/001; H04M 1/026

(57) ABSTRACT

An apparatus used to align a wireless phone camera with a magnification scope (for example a spotting scope, binocular, telescope, microscope, or similar optical devices) by attaching an alignment device to a wireless phone or matching phone case using a removable double sided adhesive strip, with the device sight hole aligned with the wireless phone camera. The eyepiece of the magnification scope is modified by placing circular elastic bands of approximately ¾ inch width, layered as necessary over the circumference of the magnification scope eyepiece such that the modified eyepiece diameter matches the slightly tapered interior diameter of the alignment device eyepiece receiving ring, such that the receiving ring can be pressed over the magnification scope eyepiece until it rests against the forward surface of the magnification scope eyepiece with a friction fit. The elastic bands are manufactured with a protruding flap or flaps, which facilitates band removal.

### BACKGROUND

1. Field of invention

The present invention relates to the use of magnification scopes and more particularly to the alignment of a camera to a magnification scope eyepiece for viewing and recording magnified images.

2. Description of the Related Art

A camera attached to a magnification scope, such as for example a wireless phone camera attached to and aligned with the eyepiece of a spotting scope, telescope, microscope, binocular, or similar optical devices, allows for the viewing of magnified images on the wireless phone display screen and the recording of images with enhanced magnification.

Attaching and aligning a wireless phone camera to a magnification scope is complicated by the variety of wireless phone design formats, and the variety of magnification scopes having eyepieces with a variety of diameters.

There are several previously disclosed devices that align wireless phone cameras with magnification scope eyepieces through the use of systems that either mechanically adjusts the device to accommodate both the desired wireless phone camera and magnification scope configurations; or a system of proprietary phone cases and properly positioned and sized eyepiece receiving rings that are specifically molded or machined to match the configuration of each desired combination of wireless phone and magnification scope eyepiece diameters.

### SUMMARY

Disclosed herein is an apparatus for attaching and aligning a variety of wireless phone camera formats with magnification scope eyepieces of various diameters. The disclosed apparatus is an improvement over existing art in that it eliminates the need for mechanically adjusted connections to both the wireless phone and magnification scope eyepiece, and/or the need to mold or machine alignment device formats that account for the combination of both the variety of proprietary wireless phone formats and hundreds of magnification scope eyepiece diameters. The disclosed apparatus is comprised of four standard alignment device formats of molded plastic, any one of which being attached to a user's wireless phone body or matching phone case using a removable double sided adhesive strip, and being aligned with the wireless phone camera (generally the rear camera), and placing circular elastic bands of various thicknesses and widths, as needed, around the circumference of a magnification scope eyepiece in order to match the interior diameter of the alignment device such that the alignment device can be pressed over the magnification scope eyepiece and bands with a friction fit. Certain of the elastic bands also having a protruding flap or flaps to facilitate hand removal.

The current four standard alignment device formats include eyepiece receiving ring interior diameters of 1.33 inches, 1.66 inches, 1.99 inches, and 2.33 inches at the base, and slightly tapered outward over its length to provide a variable diameter.

### BRIEF DESCRIPTION OF THE DRAWINGS

FIG. 1 is an upper perspective view, showing the present invention alignment device with flat base surface, three tab receiving ring, tapered interior surface, sight hole, and lanyard hole.

FIG. 2 is a lower perspective view, showing the present invention alignment device with flat base surface, three tab receiving ring, sight hole, camera recess, tapered interior surface, lanyard hole, and depicts an attached removable double sided adhesive strip at the typical location.

FIG. 3 is a perspective view, showing a circular rubber band element of the present invention, used as a method of attachment wherein the bands are placed around the eyepiece of a magnification scope to modify the diameter of the eyepiece to match the diameter of the appropriate alignment device. The band is depicted with a single removal flap.

FIG. 4 is a perspective view depicting three circular rubber band elements of the present invention place around a cylinder representing a magnification scope eyepiece, and an alignment device, and a removable double sided adhesive strip and a representation of a typical wireless phone with camera.

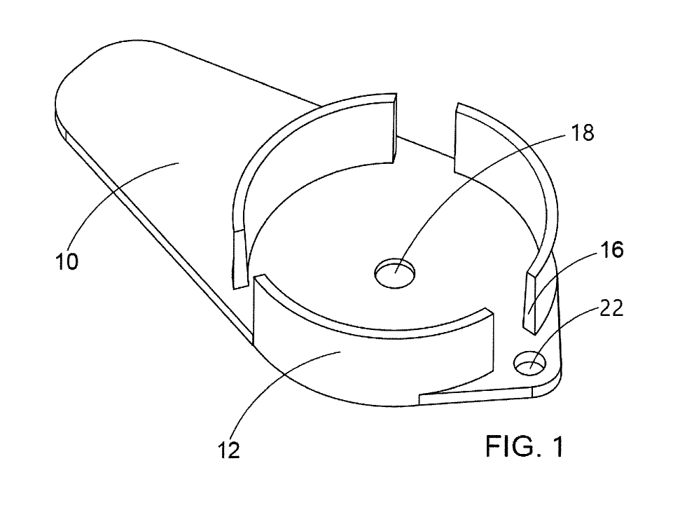

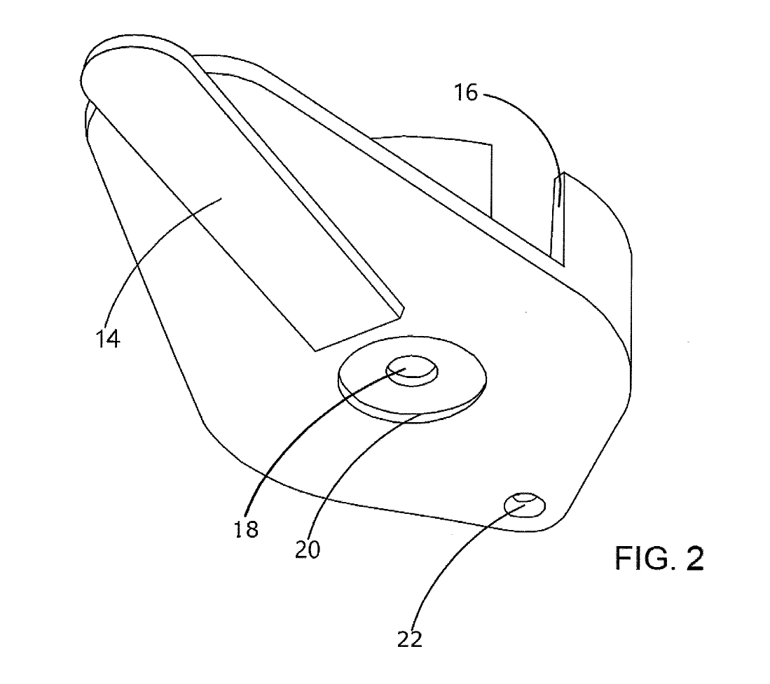

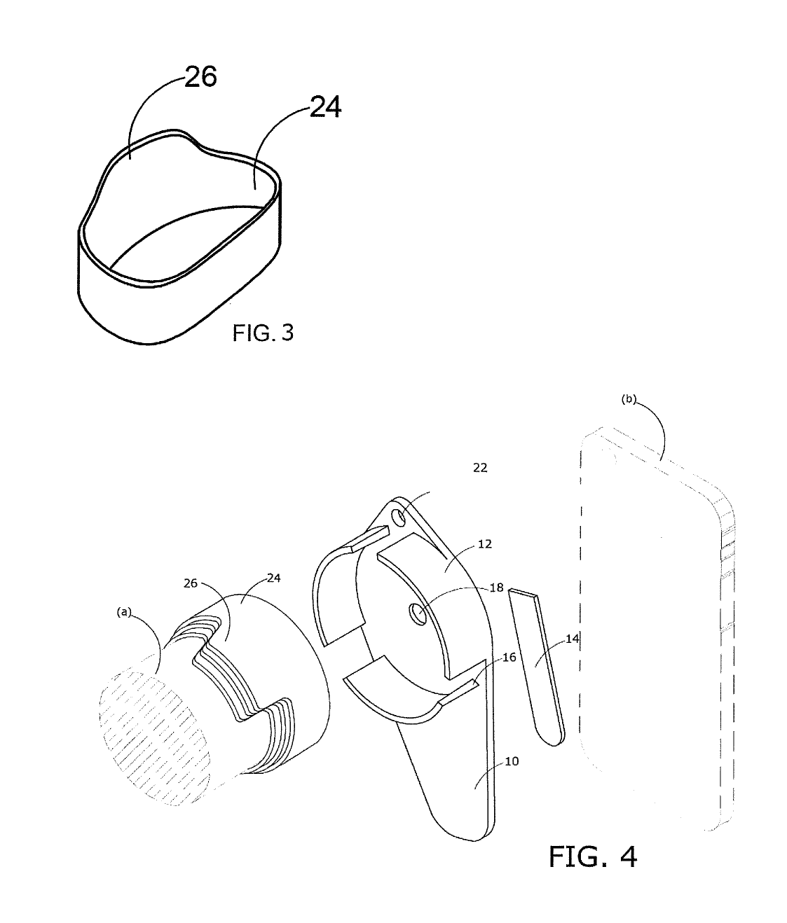

### REFERENCE NUMBERS IN THE DRAWINGS

10 alignment device flat base surface

12 alignment device receiving ring

14 removable double sided adhesive strip

16 receiving ring tapered interior surface

18 alignment device sight hole

20 alignment device lens recess

22 alignment device lanyard hole

24 circular elastic band

26 circular elastic band removal tab option

(a) representation of a magnification scope eyepiece

(b) representation of a typical wireless phone with camera

### DETAILED DESCRIPTION

Each alignment device format consists of a flat base surface, shaped similar to a teardrop to provide a wider circular portion equal to the outside diameter of a three tab eyepiece receiving ring, and a diminishing surface area upon which to apply a removable double sided adhesive strip. The three tab receiving ring is integral to the base consisting of an approximately ¾ inch long cylinder of multiple alternating radius tabs and gaps in a circular pattern with a diameter equal to or slightly greater than the diameter of the scope eyepiece on which it is intended to be fitted; the interior surface diameter of the three tab receiving ring being slightly tapered to give variations to fit. At the center of the three tab eyepiece receiving ring is a sight hole that penetrates through the flat base surface and is positioned to align with the wireless phone camera and the center of the scope view area when fitted. Opposite the eyepiece receiving ring on the base surface and centered around the sight hole is a recessed element which accommodates camera lenses that may protrude beyond the surface of some wireless phone formats. Another hole is provided through the flat base for a lanyard connection.

The user attaches the alignment device to the wireless phone body or matching phone case using a removable double sided adhesive strip, with the sight hole being aligned with the camera. The user modifies the diameter of the magnification scope eyepiece using the quantity of circular elastic bands of approximately % inch width and various thicknesses as necessary to match the interior diameter of the three tab receiving ring on the alignment device such that the eyepiece receiving ring can be pressed to cover the magnification scope eyepiece with a friction fit.

A portion of the disclosure of this patent document contains material which is subject to (copyright or mask work) protection. The (copyright or mask work) owner has no objection to the facsimile reproduction by anyone of the patent document or the patent disclosure, as it appears in the Patent and Trademark Office patent file or records, but otherwise reserves all (copyright or mask work) rights whatsoever.

1. A device for aligning a camera, typical of a wireless phone, with the eyepiece of a magnification scope (for example a spotting scope, telescope, microscope, binocular, or similar optical devices), said alignment device featuring:
a. an approximately ⅛ inch thick flat teardrop shaped base as a foundation surface, and
b. an approximately ¾′ long three tab eyepiece receiving ring with tapered interior surface, integral to the base, and
c. a sight hole through the base at the center of the three tab eyepiece receiving ring through which the camera and magnification scope eyepiece are aligned, and
d. a camera lens recess in the base opposite the three tab eyepiece receiving ring placed to avoid contact with wireless phone camera lenses that may protrude beyond the body of the wireless phone.

2. A method of attachment of the device in claim 1 to a wireless phone or matching phone case using a removable double-sided adhesive strip placed along the elongated surface of the device base on the side opposite the three tab eyepiece receiving ring.

3. A method of modifying the diameter of a magnification scope eyepiece using
a. a number of approximately ¾ inch wide circular elastic bands of various thicknesses around the circumference of a magnification scope eyepiece as needed to match one of the standard device formats of claim 1, and
b. each band having a protruding flap or flaps to promote band removal.
